(19) United States
(12) Patent Application Publication
(10) Pub. No.: US 2018/0132678 A1
(43) Pub. Date: May 17, 2018

(54) Toilet Bowl Cleaner with Disposable Cleaning Head

(71) Applicants: Franklin Farrow, Rancho Palos Verdes, CA (US); Dominic Peralta, San Mateo, CA (US); David Law, Palo Alto, CA (US)

(72) Inventors: Franklin Farrow, Rancho Palos Verdes, CA (US); Dominic Peralta, San Mateo, CA (US); David Law, Palo Alto, CA (US)

(21) Appl. No.: 15/816,927

(22) Filed: Nov. 17, 2017

Related U.S. Application Data
(60) Provisional application No. 62/423,737, filed on Nov. 17, 2016.

(51) Int. Cl. A47K 11/10; B25G 1/04; B25G 1/08; B25G 3/10

(52) U.S. Cl. CPC A47K 11/10; B25G 3/10; B25G 1/08; B25G 1/04

(57) ABSTRACT

Toilet bowl cleaning systems are described. The toilet bowl cleaning system incorporates a reusable handle and one or more dissolvable cleaning heads configured to engage with the reusable handle. The dissolvable cleaning heads are formed of a cleaning material that dissolves over a predetermined time when exposed to water. The reusable handle has an interconnecting end that is provided with an engagement point that cooperatively interacts with the dissolvable head to provide a secure connection. The connection may be physical, such as frictional or mechanical in nature. The connection may be chemical in nature, such as an adhesive that may be activated via a liquid, such as water.

### CROSS-REFERENCE TO RELATED APPLICATIONS

The present application claims priority to U.S. Patent Application No. 62/423,737, entitled “Toilet Bowl Cleaner with Disposable Cleaning Head” to Farrow et al., filed Nov. 17, 2016, the disclosure of which is incorporated herein by reference in its entirety.

### FIELD OF THE INVENTION

Toilet bowl cleaning devices, including disposable cleaning head are described.

### BACKGROUND OF THE INVENTION

Toilet brushes generally are located by users on the floor near the toilet bowl or in a bathroom cupboard nearby. These brushes tend to be bulky, unsightly and repositories of disease bearing germs. A recent improvement has been the introduction of brushes with disposable heads. However, these types of brushes create unwanted waste resulting from the need to dispose of each head. Similarly, the cleaning chemicals used in association with these types of brushes are either applied using water cistern/bowl tablets that dissolve over a period of weeks or via a bottle/spray that acts immediately when the toilet is cleaned. Both of these chemical treatments require the use of a separate material that must be stored and co-located near the brush, and which does not act on their own without application of the associated brush.

### BRIEF SUMMARY OF THE INVENTION

The application is directed to toilet bowl cleaning devices.

In many embodiment a toilet bowl cleaning system may include:
a reusable handle comprising an elongated body having first and second ends; and
at least one separable cleaning head comprising a scrubbing body formed of a fully dissolvable cleaning material and having an interconnection opening configured to cooperatively engage the second end of the handle such that the handle and cleaning head are securely interconnected.

In some such embodiments the interconnection opening of the cleaning head and second end of the handle comprise cooperative frictional fittings to provide secure engagement therebetween.

In other such embodiments the frictional fittings comprise a projection and cooperative indentation.

In still other such embodiments the cleaning head further comprises at least one expansion channel disposed in the outer wall of the cleaning head such that the cleaning head may elastically deform during engagement with frictional fitting on the handle.

In yet other such embodiments an adhesive material is disposed within the interconnection opening.

In still yet other such embodiments the adhesive material is a water activated adhesive material.

In still yet other such embodiments the second end of the handle comprises an expandable element configured to engage a cooperative channel in the interconnection opening when expanded.

In still yet other such embodiments the system further includes a container comprising a volume for containing a plurality of cleaning heads.

In still yet other such embodiments the system further includes:
an outer sleeve disposed circumferentially about at least a portion of the handle, the outer sleeve defining a circumferential volume disposed between an outer wall of the handle and an inner wall of the sleeve;
wherein the cleaning head comprises a ring of cleaning materials configured to be disposed circumferentially about the outer wall of the handle;
wherein the circumferential volume is configured to contain at least one cleaning head; and
wherein the outer sleeve further comprises a dispensing opening distal to the first end configured to sequentially release one cleaning head from the circumferential volume such that the cleaning head may slide down the handle proximal to the second end to engage therewith.

In still yet other such embodiments the second end tapers outward to cooperatively engage an inner circumferential wall of the cleaning head to secure the cleaning head to the second end of the handle.

In still yet other such embodiments the circumferential volume is configured to contain a plurality of cleaning heads.

In still yet other such embodiments the plurality of cleaning heads are configured to nest together in an overlapping manner.

In still yet other such embodiments the system further includes a dispensing mechanism disposed proximal to the first end of the handle and interconnected with the dispensing opening such that operation of the dispensing mechanism opens the dispensing opening to release a cleaning head from the circumferential volume.

In still yet other such embodiments the system further includes an alignment feature disposed on the handle and a cooperative alignment channel disposed on the cleaning head such that the attachment of the cleaning head onto the handle requires aligning of the alignment feature and alignment channel.

In still yet other such embodiments the alignment feature is disposed proximal to the second end of the handle.

In still yet other such embodiments the alignment feature comprises a narrowed circumferential section of the handle.

In still yet other such embodiments the head cleaning head has a non-geometric shape.

In still yet other such embodiments the cleaning material comprises fibers disposed in a matrix of cleaning material.

In still yet other such embodiments the cleaning material is configured to have a roughened texture.

In still yet other such embodiments the handle includes:
an internal volume configured to contain at least one cleaning head;
an opening disposed in the second end of the handle such that one of the cleaning heads may extend therefrom; and
further comprising a dispensing mechanism configured to dispense a cleaning head contained within the internal volume through the opening.

In still yet other such embodiments the dispensing mechanism includes a rotatory element disposed in the handle interconnected with a screw element configured to extend a cleaning head through the opening.

In still yet other such embodiments the cleaning head includes a solid elongated body of cleaning material disposed within the internal volume and configured such that the proximal end of the elongated body of cleaning material extends out of the opening when dispensed.

In still yet other such embodiments the dispensing mechanism includes a rotatory element disposed in the handle interconnected with a screw element configured to extend a cleaning head through the opening, wherein the outer surface of the elongated body of cleaning material is threaded, and wherein the threading is configured to engage with the dispensing mechanism such that rotation of dispensing mechanism causes extension of the cleaning material out of the opening.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 provides a schematic view of a toilet bowl cleaning system in accordance with embodiments.

FIG. 2 provides a schematic close-up view of a toilet bowl cleaning system head in accordance with embodiments.

FIGS. 3a to 3c provide cross-sectional views of a mechanism for interconnecting a reusable handle to a dissolvable cleaning head in accordance with embodiments.

FIGS. 4a to 4c provide cross-sectional views of a mechanism for dispensing and interconnecting a reusable handle to a dissolvable cleaning head in accordance with embodiments.

FIGS. 5a and 5b provide cross-sectional views of a mechanism for interconnecting a reusable handle to a dissolvable cleaning head in accordance with embodiments.

FIGS. 6a and 6b provide schematic and cross-sectional views of a mechanism for interconnecting a reusable handle to a dissolvable cleaning head in accordance with embodiments.

FIGS. 7a and 7b provide schematic and cross-sectional views of a mechanism for interconnecting a reusable handle to a dissolvable cleaning head in accordance with embodiments.

FIGS. 8a and 8b provide schematic and cross-sectional views of a mechanism for interconnecting a reusable handle to a dissolvable cleaning head in accordance with embodiments.

FIG. 9 provides schematic views of various dissolvable cleaning head designs in accordance with embodiments.

FIGS. 10a and 10b provide schematic views of various materials for forming dissolvable cleaning head designs in accordance with embodiments.

FIG. 11 provides schematic and cross-sectional views of a toilet bowl cleaning device dispensing mechanism in accordance with embodiments.

FIGS. 12a and 12b provide cross-sectional views of a toilet bowl cleaning device dispensing mechanism in accordance with embodiments.

### DETAILED DESCRIPTION OF THE INVENTION

Turning now to the drawings, toilet bowl cleaning systems are described. In many embodiments, the toilet bowl cleaning system incorporates a reusable handle and one or more dissolvable cleaning heads configured to engage with the reusable handle. In various embodiments the dissolvable cleaning heads are formed of a cleaning material that dissolves over a predetermined time when exposed to water. In other embodiments the reusable handle has an interconnecting end that is provided with an engagement point that cooperatively interacts with the dissolvable head to provide a secure connection. In many embodiments the connection is physical, such as frictional or mechanical in nature. In other embodiments the connection is chemical in nature, such as an adhesive that may be activated via a liquid, such as water.

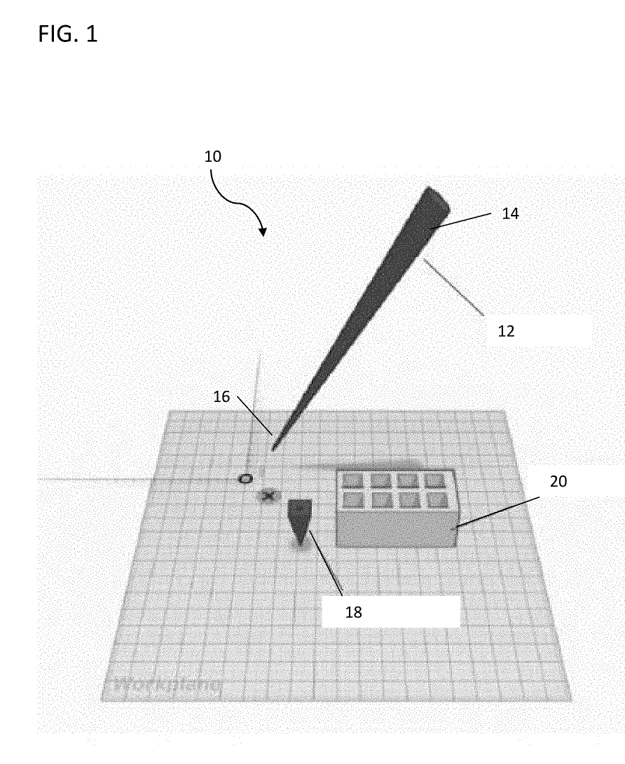

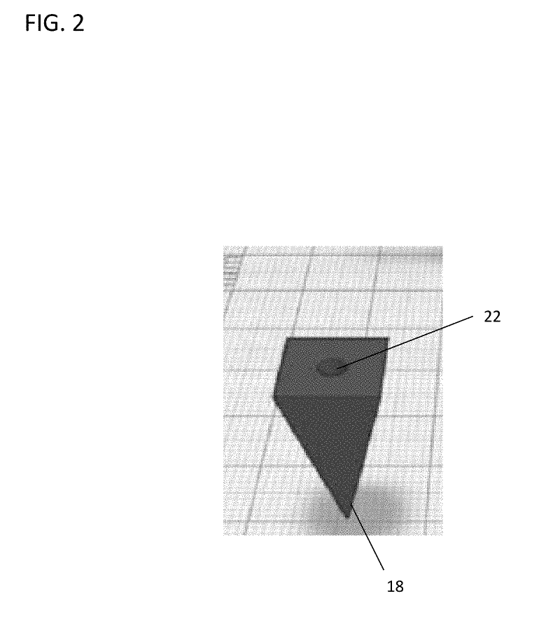

FIGS. 1 and 2 provide schematic views of a toilet bowl cleaning system (10) in accordance with embodiments. As shown, in many embodiments the system (10) includes a reusable handle (12) that has a first end configured for the user to grip (14), and a second end (16) configured to securely engage a dissolvable cleaning head (18). The system may also include a container or dispenser (20) to store and dispense the dissolvable cleaning heads. FIG. 2 provides a detailed schematic view of a cleaning head (18) in accordance with embodiments. As shown, the head generally comprises a scrubbing body having a desired shape, and a interconnection point (22) configured to cooperatively engage the reusable handle (12). Although a specific design of handle, cleaning head and dispenser is provided in the figures, it will be understood that each of these items may be conformed to any design suitable for the intended purpose.

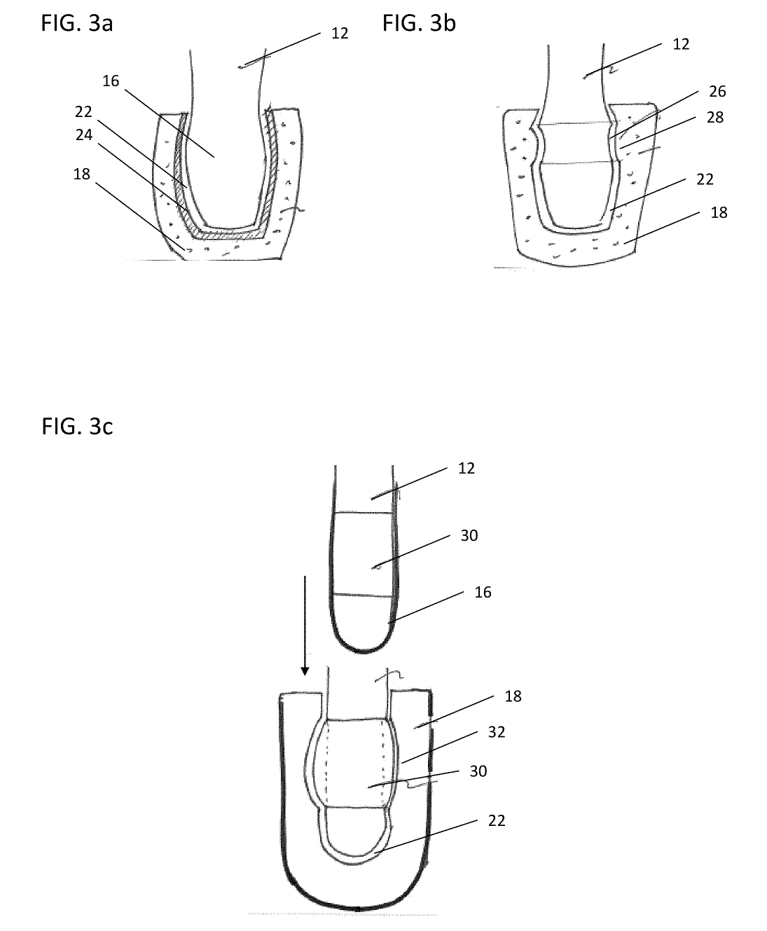

Turning to the interconnection between the reusable handle and the dissolvable head, as shown in FIGS. 3a to 3c, it should be understood that a number of different types of interconnection can be implemented in accordance with embodiments. In various embodiment, the interconnection point (22) of the dissolvable cleaning head (18) could incorporate an internal adhesive (24) to securely interconnect the head to the wand handle (12) when the wand handle is engaged into the interconnection point. In many such embodiments, the adhesive could be water activated such that the head and handle only become securely attached when wetted, such as for example, when the cleaning head is submerged in the bowl of the toilet. In other embodiments, as shown in FIG. 3b, a frictional fitting could be implemented. In many such embodiments, the second end (16) of the wand handle (12) and the interconnection point (22) of the cleaning head (18) may incorporate engagement features (26 & 28) that are configured to cooperatively engaged to provide a secure interconnection therebetween. Although FIG. 3b provides an exemplary frictional fitting where the engagement feature (26) of the wand handle (12) comprises a recess and the cleaning head (18) has an engagement feature (28) comprises a cooperative projection, it should be understood that these features may be reversed or other suitable arrangements of features that provide a frictional fitting may be used. Still other embodiments could incorporate a mechanical system, such as an inflatable element in the tip of the reusable handle that could be activated by the user to grip the cleaning head, as shown in FIG. 3c. In many such embodiments the second end (16) of the wand handle (12) may incorporate an inflatable element (30) that can be activated to engage a cooperative engagement feature (32) once the second end of the wand handle is inserted within the interconnection point (22) of the cleaning head (18). Again, although a specific shape and nature of mechanical feature is shown in FIG. 3c, it will be understood that many suitable mechanical engagement elements may be implemented in accordance with such embodiments.

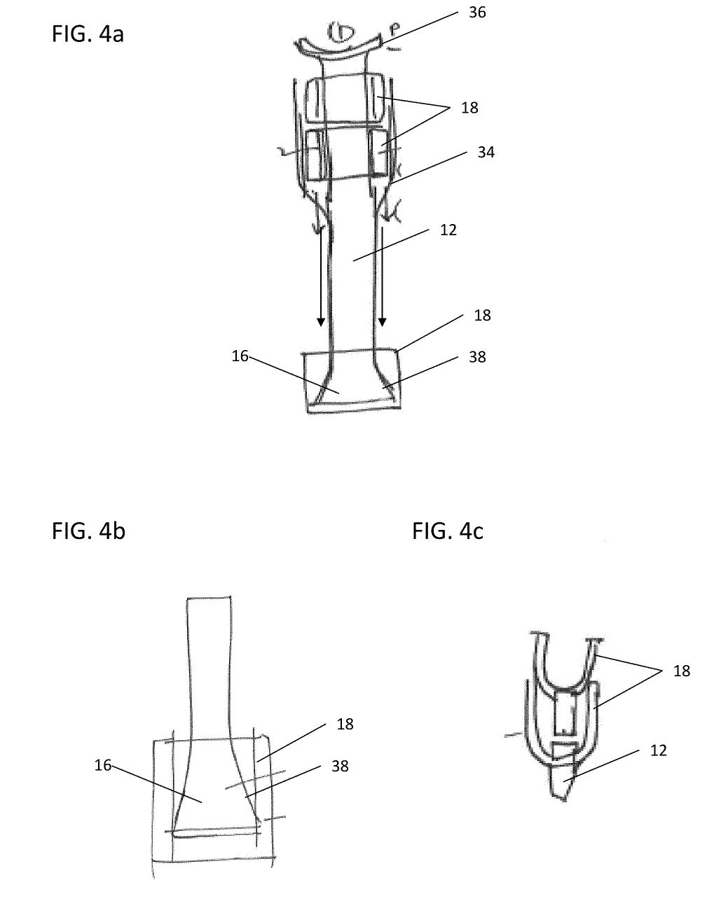

Although the embodiments shown in FIG. 3 describe systems where the cleaning head is separate from the reusable handle until they are interconnected, other embodiments may incorporate a dispensing mechanism along or within the handle to contain the cleaning heads. Schematic drawings of some exemplary systems are shown in FIGS. 4a to 4c. In some such embodiments, as shown in FIG. 4a, the cleaning heads (18) could be held in a receptacle (34) along the length of the reusable handle (12). A dispensing mechanism (36), such as, for example, a plunger mechanism, is then provided to release a cleaning head to slide down the shaft of the handle to the second end (16) of the handle (12). In various embodiments, as shown in detail in FIG. 4b, the second end (16) of the handle (12) may be tapered (38) such that the cleaning head (18) becomes securely lodged at the second end (16) of the handle (12) to allow for cleaning. Although one arrangement of dispensing heads is shown in FIGS. 4a and 4b, it will be understood that other arrangements may also be provided. In one such embodiment, as shown in FIG. 4c, the heads (18) may be configured to nest or stack such that less space within the enclosure of the handle (12) is required. In addition, although not shown, in other embodiments the cleaning head could also be coated with water-activate adhesive such that when inserted into the toilet bowl the adhesive activated providing additional holding security.

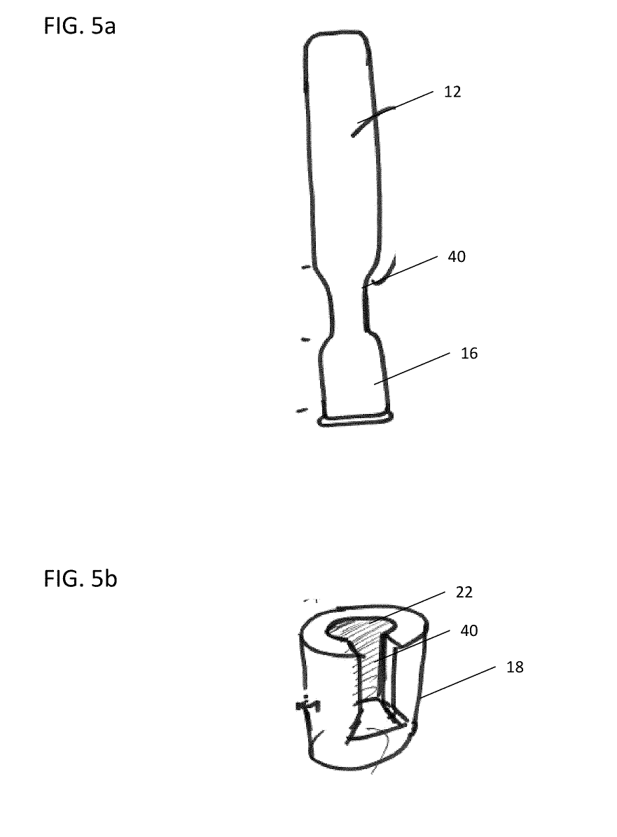

In other embodiments, as shown in FIGS. 5a and 5b, the cleaning head (18) and reusable handle (12) could be formed with cooperative shapes, such as a geometric key element (40), such that the key elements on the handle and the cleaning head must be aligned to allow for attachment of the cleaning head into the interconnection point (22) of the handle. Although these geometric key elements may be disposed anywhere along the handle and cleaning head appropriate, it will be understood in various embodiments, the geometric key element of the handle is disposed on the second end (16) of the handle (12). Regardless of the specific arrangement of the geometric key element, such a mechanism would allow secure attachment such that removal of the cleaning head could not be affected without careful alignment of the features. As with other embodiments, this mechanical attachment design could be incorporated with an adhesive material to provide additional security.

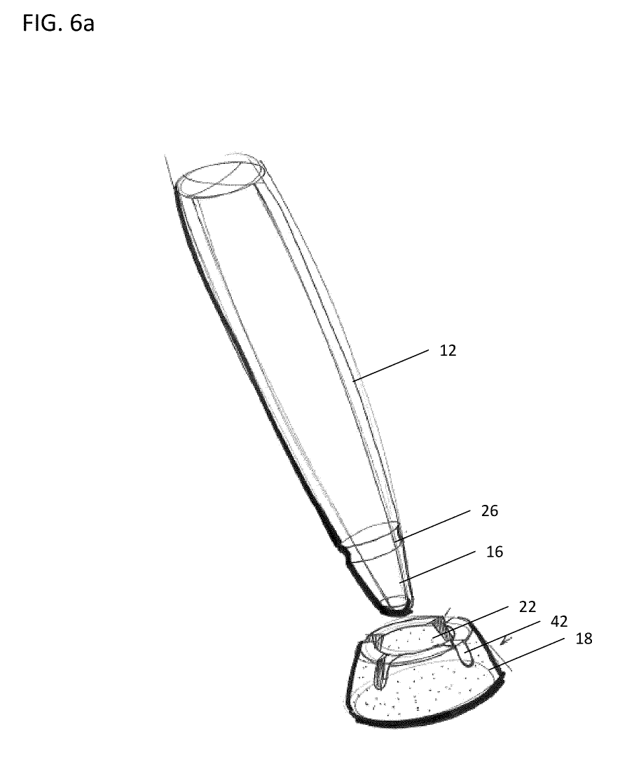

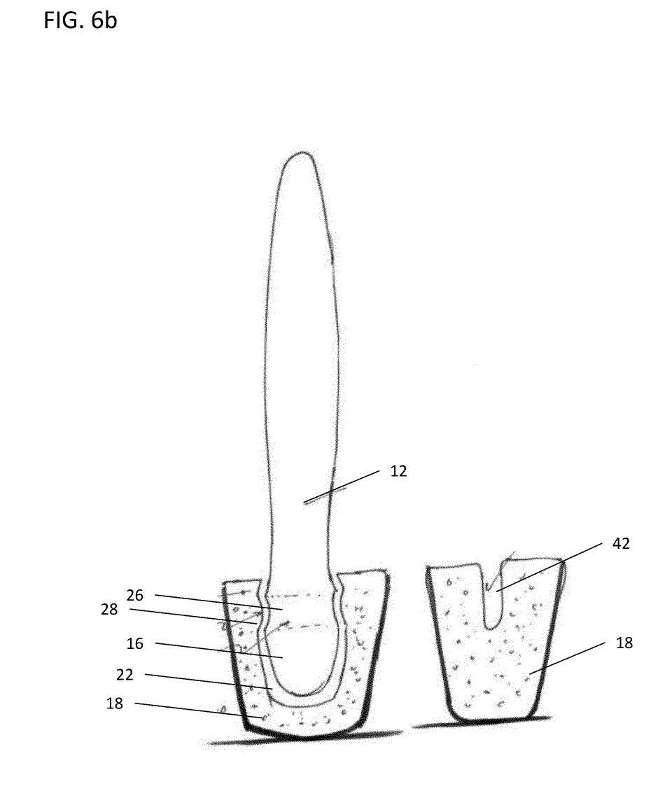

As described previously, many embodiments may incorporate a frictional fitting between the reusable handle and the cleaning head. One such embodiment is shown in FIGS. 6a and 6b. In such an embodiment, as shown in the figures, the handle (12) and cleaning head (18) may include cooperative engagement features (such as a recess on the handle (26) and projection on the cleaning head (28)) that allow the secure interconnection therebetween. To allow the two pieces to fit together, the cleaning head (18) may incorporate cut outs (42) to allow the head to deform during attachment, i.e., expand and then contract again once in final position.

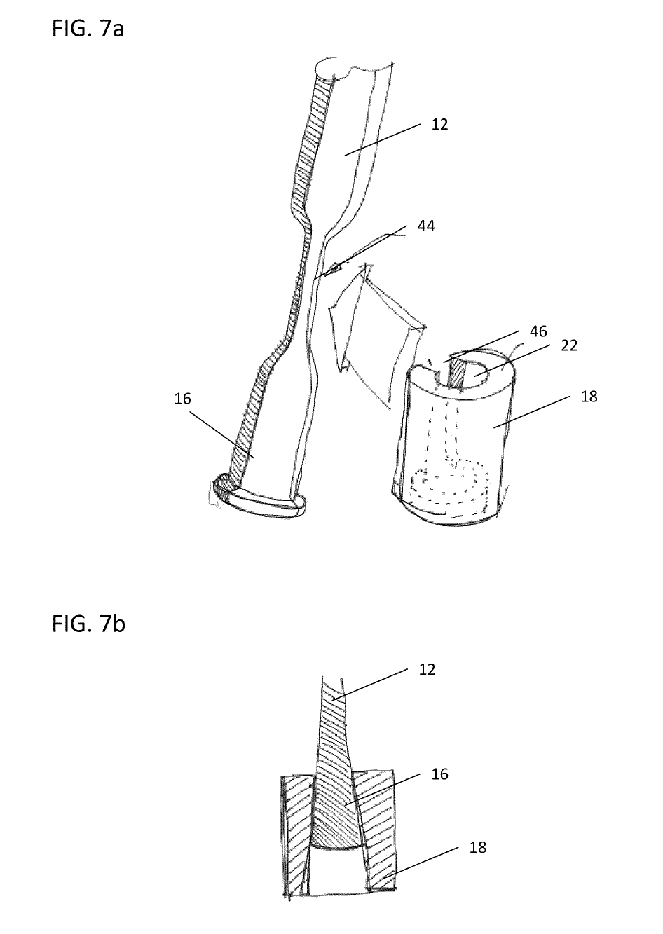

As shown in FIGS. 7a and 7b, in other embodiments the cross-section of the reusable handle (12) might be configured to allow the cleaning head (18) to be insert securely there-on. As shown, in the exemplary embodiment shown in FIG. 7a, the cross-section of the reusable handle may have an attachment section (44) (e.g., a narrow portion) dimensioned to be cooperative with an insertion feature (46) on the cleaning head (e.g. a slit along the side). In such embodiments, the cleaning head could be engaged with the handle by sliding the cleaning feature on the handle at the attachment section using the insertion feature. Once engaged with the handle, the cleaning head would then slide along the handle (12) to the second end (16) thereof. As shown in FIG. 7b, the cross-section of the handle (12) may have a cross-section that expands toward the second end (16) of the handle such that the cleaning head is securely fitted thereto once engaging the second end.

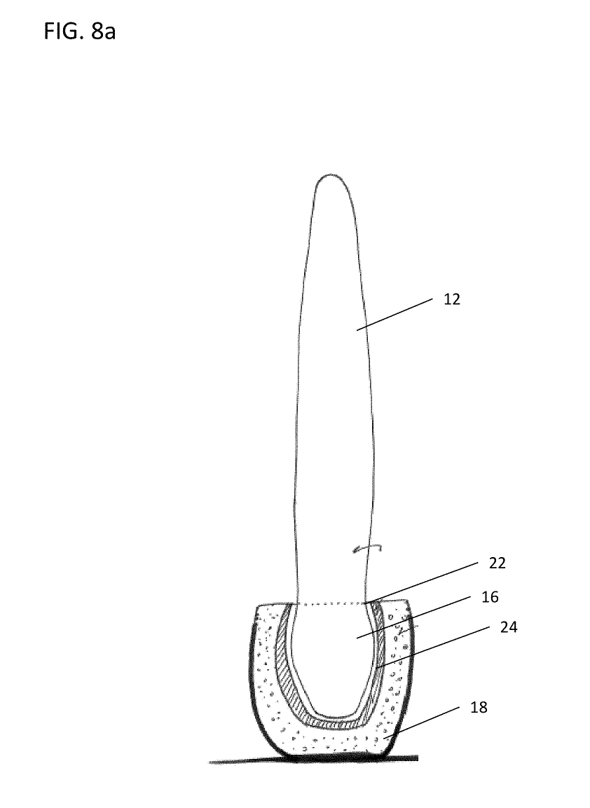

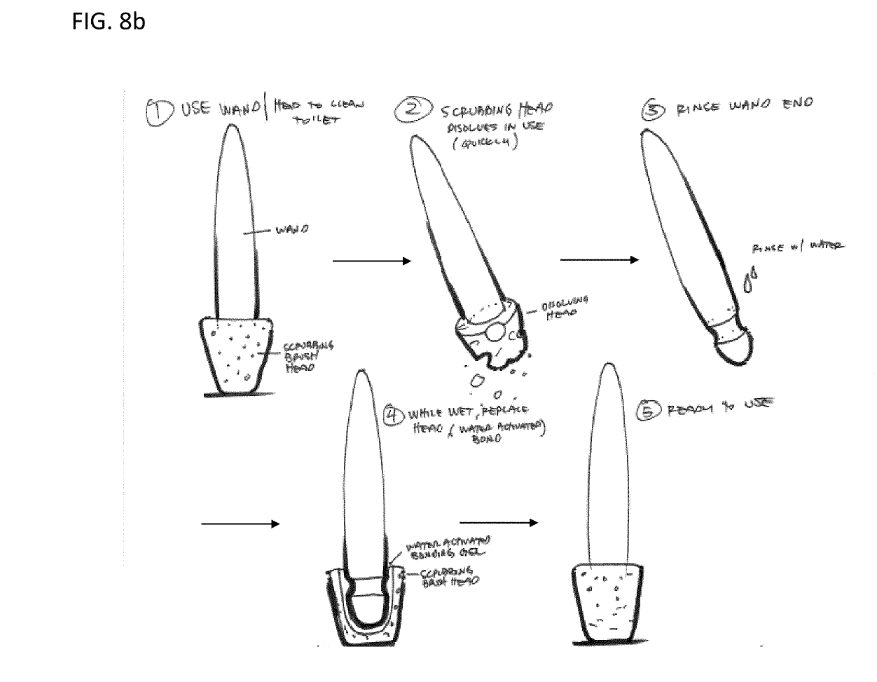

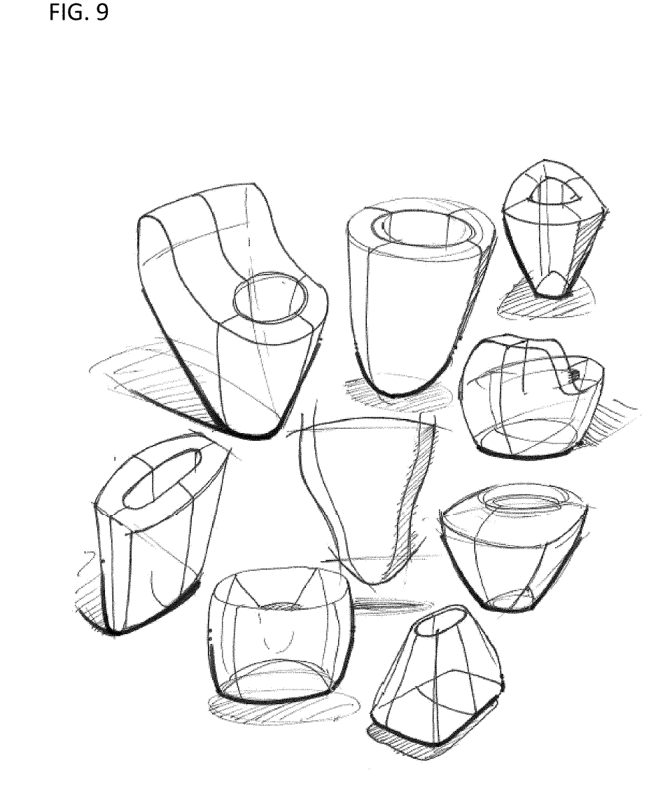

In many other embodiments, as shown schematically in FIGS. 8a and 8b, the cleaning head may be attached to the reusable handle primarily through an adhesive, such as a water activated adhesive. In such embodiments, as shown in FIG. 8a, the interconnection point (22) in the cleaning head (18) into which the second end (16) of the reusable handle (12) is inserted may be coated with the adhesive material (24). In many such embodiments, the adhesive may be water activated. As shown in FIG. 8b, in using such a system the cleaning head would dissolve over time (step 2). Once the cleaning procedure is complete the attachment end of the handle could be rinsed (step 3) and a new cleaning head attached thereto (steps 4 and 5) to ready the system for use again.

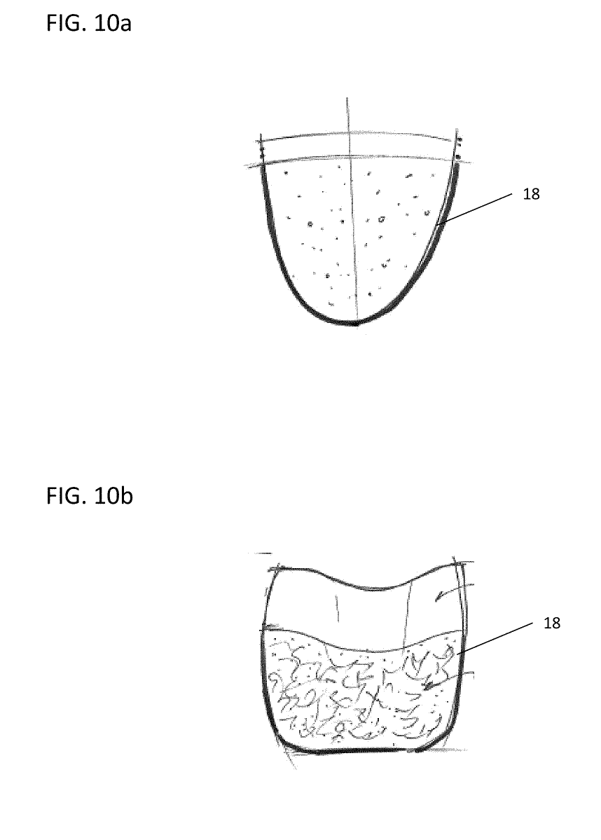

Although various head designs are shown in the embodiments, it should be understood that the head may take any suitable shape, and may include features such as projections, edges, etc. to allow for the cleaning head to be configured for cleaning specific features of the toilet bowl like the underside of the toilet bowl rim, as provided in FIG. 9. In addition, the cleaning heads may take the form of a desired figure, such as a popular figure or the likeness of an individual. As shown in FIGS. 10a and 10b, the cleaning heads (18) may also include external surface features or consistencies, such as roughening (FIG. 10a) or fibers (FIG. 10b), to allow the cleaning head to have better cleaning efficacy.

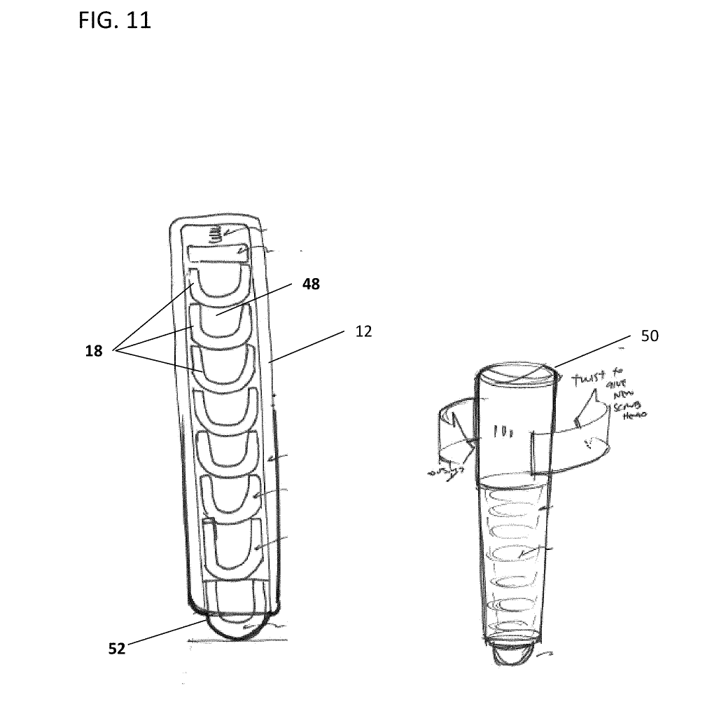

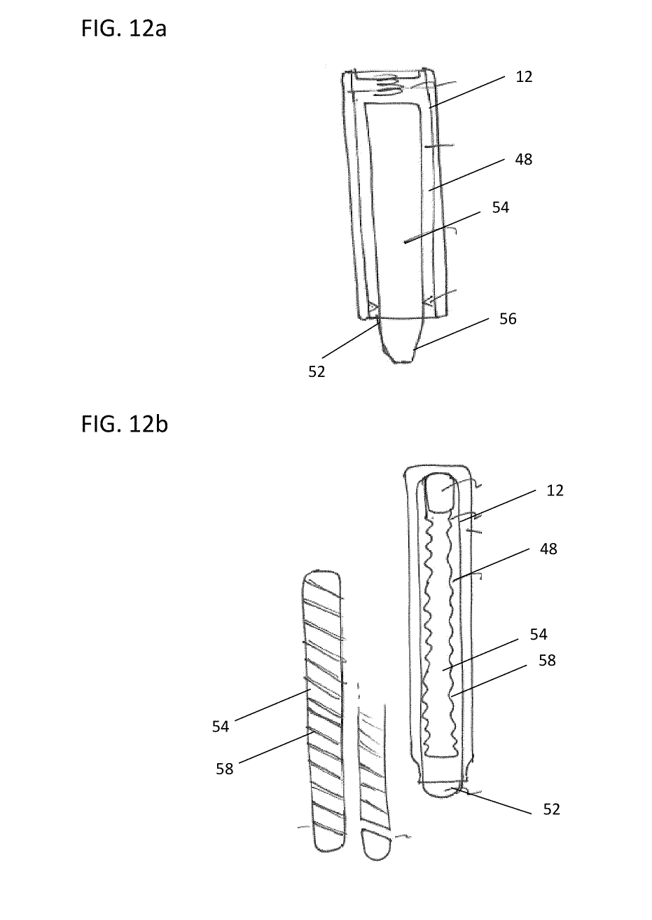

In still other embodiments, as shown in FIGS. 11 and 12, the reusable handle could serve as a receptacle for the cleaning head material. In some such embodiments, as shown in FIG. 11, the handle (12) could define and internal volume (48) capable of serving as a repository for a plurality of separate dissolvable cleaning heads (18). A dispensing mechanism (50) (e.g., a twisting or plunging mechanism) could be provided to force a new cleaning head out of an opening (52) at the second end (16) of the handle for use. During use the cleaning head would dissolve allowing for a new head to be ejected. In other embodiments, as shown in FIGS. 12a and 12b, the cleaning head (18) may be configured as a solid length or sectioned length of cleaning material (54) that could be extended from within an internal volume (48) of the reusable handle body (12) through an opening (52) at the second end (16) of the handle (12). The exposed portion (56) could then be used to clean the toilet bowl and would dissolve during use. More material could then be ejected as necessary. In some such embodiments, as shown in FIG. 12b, in some such embodiments the elongated length of the cleaning material (54) may be grooved (58) in a spiral manner to allow the length of cleaning material to be extended via a twisting or rotatory mechanism.

### DOCTRINE OF EQUIVALENTS

It should be understood that although the illustrated embodiments show specific configurations of reusable handles, cleaning heads, attachment mechanisms, etc. that these elements could be modified substantially while maintaining the functionality of the toilet bowl cleaning system. In particular, as can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A toilet bowl cleaning system comprising:
a reusable handle comprising an elongated body having first and second ends; and
at least one separable cleaning head comprising a scrubbing body formed of a fully dissolvable cleaning material and having an interconnection opening configured to cooperatively engage the second end of the handle such that the handle and cleaning head are securely interconnected.

2. The toilet bowl cleaning system of claim 1, wherein the interconnection opening of the cleaning head and second end of the handle comprise cooperative frictional fittings to provide secure engagement therebetween.

3. The toilet bowl cleaning system of claim 2, wherein the frictional fittings comprise a projection and cooperative indentation.

4. The toilet bowl cleaning system of claim 3, wherein the cleaning head further comprises at least one expansion channel disposed in the outer wall of the cleaning head such that the cleaning head may elastically deform during engagement with frictional fitting on the handle.

5. The toilet bowl cleaning system of claim 1, wherein an adhesive material is disposed within the interconnection opening.

6. The toilet bowl cleaning system of claim 5, wherein the adhesive material is a water activated adhesive material.

7. The toilet bowl cleaning system of claim 1, wherein the second end of the handle comprises an expandable element configured to engage a cooperative channel in the interconnection opening when expanded.

8. The toilet bowl cleaning system of claim 1, further comprising a container comprising a volume for containing a plurality of cleaning heads.

9. The toilet bowl cleaning system of claim 1, further comprising:
an outer sleeve disposed circumferentially about at least a portion of the handle, the outer sleeve defining a circumferential volume disposed between an outer wall of the handle and an inner wall of the sleeve;
wherein the cleaning head comprises a ring of cleaning materials configured to be disposed circumferentially about the outer wall of the handle;
wherein the circumferential volume is configured to contain at least one cleaning head; and
wherein the outer sleeve further comprises a dispensing opening distal to the first end configured to sequentially release one cleaning head from the circumferential volume such that the cleaning head may slide down the handle proximal to the second end to engage therewith.

10. The toilet bowl cleaning system of claim 9, wherein the second end tapers outward to cooperatively engage an inner circumferential wall of the cleaning head to secure the cleaning head to the second end of the handle.

11. The toilet bowl cleaning system of claim 9, wherein the circumferential volume is configured to contain a plurality of cleaning heads.

12. The toilet bowl cleaning system of claim 11, wherein the plurality of cleaning heads are configured to nest together in an overlapping manner.

13. The toilet bowl cleaning system of claim 9, further comprising a dispensing mechanism disposed proximal to the first end of the handle and interconnected with the dispensing opening such that operation of the dispensing mechanism opens the dispensing opening to release a cleaning head from the circumferential volume.

14. The toilet bowl cleaning system of claim 1, further comprising an alignment feature disposed on the handle and a cooperative alignment channel disposed on the cleaning head such that the attachment of the cleaning head onto the handle requires aligning of the alignment feature and alignment channel.

15. The toilet bowl cleaning system of claim 14, wherein the alignment feature is disposed proximal to the second end of the handle.

16. The toilet bowl cleaning system of claim 14, wherein the alignment feature comprises a narrowed circumferential section of the handle.

17. The toilet bowl cleaning system of claim 1, wherein the head cleaning head has a non-geometric shape.

18. The toilet bowl cleaning system of claim 1, wherein the cleaning material comprises fibers disposed in a matrix of cleaning material.

19. The toilet bowl cleaning system of claim 1, wherein the cleaning material is configured to have a roughened texture.

20. The toilet bowl cleaning system of claim 1, wherein the handle comprises:
an internal volume configured to contain at least one cleaning head;
an opening disposed in the second end of the handle such that one of the cleaning heads may extend therefrom; and
further comprising a dispensing mechanism configured to dispense a cleaning head contained within the internal volume through the opening.

21. The toilet bowl cleaning system of claim 20, wherein the dispensing mechanism comprises a rotatory element disposed in the handle interconnected with a screw element configured to extend a cleaning head through the opening.

22. The toilet bowl cleaning system of claim 20, wherein the cleaning head comprises a solid elongated body of cleaning material disposed within the internal volume and configured such that the proximal end of the elongated body of cleaning material extends out of the opening when dispensed.

23. The toilet bowl cleaning system of claim 22, wherein the dispensing mechanism comprises a rotatory element disposed in the handle interconnected with a screw element configured to extend a cleaning head through the opening, wherein the outer surface of the elongated body of cleaning material is threaded, and wherein the threading is configured to engage with the dispensing mechanism such that rotation of dispensing mechanism causes extension of the cleaning material out of the opening.
